(19) United States
(12) Patent Application Publication
(10) Pub. No.: US 2003/0129519 A1
(43) Pub. Date: Jul. 10, 2003

(54) Production method of electrostatic latent image developing toner

(76) Inventors: Shoichiro Ishibashi, Tokyo (JP); Ken Ohmura, Tokyo (JP); Akira Ohira, Tokyo (JP); Masafumi Uchida, Tokyo (JP)

Correspondence Address: Cameron Kerrigan, Squire, Sanders & Dempsey L.L.P., Suite 300, One Maritime Plaza, San Francisco, CA, 94111, US

(21) Appl. No.: 10/305,642

(22) Filed: Nov. 26, 2002

(30) Foreign Application Priority Data
Dec. 7, 2001 (JP) 2001-374000

(51) Int. Cl. C08J 3/215; G03G 9/08

(52) U.S. Cl. 430/137.14; 430/137.1

(57) ABSTRACT

A production method of electrostatic latent image developing toner, comprising: a colored particle forming step of forming colored particles in water-based medium; a first separation step of separating the colored particles from the water-based medium; a dispersing step of dispersing the colored particles into a washing medium; a skimming step of skimming impurities other than the colored particles together with at least a part of the washing medium, the impurities drifting on the washing medium; and a drying step of dry the colored particle so as to make the water content of the colored particles being 3% or less.

### FIELD OF THE INVENTION

The present invention relates to a production method of an electrostatic latent image developing toner employed in copiers and printers.

### BACKGROUND OF THE INVENTION

In recent years, image quality produced by copiers and printers has been increasingly enhanced. In order to enhance the image quality still further, considered as the most effective means are decreasing the diameter of an electrostatic latent image developing toner particles (hereinafter occasionally referred simply to as toner), and formation of toner particles having uniform shape as well as uniform size distribution.

In order to decrease the diameter of the toner particles and to render the particle shape and particle size distribution uniform, a toner (a polymerization toner) prepared employing a so-called polymerization method in which after dispersing monomers into a water-based medium, resinous particles are prepared employing a polymerization reaction, is of advantage.

However, in the production method of the polymerization toner, many problems remain which need to be overcome.

According to recent analysis performed by the inventors of the present invention, it was specifically discovered that impurities such as release agent particles or particles of release agent decomposition products released from colored particles (hereinafter occasionally referred to as a toner or toner particles) drift in polymerization toner dispersion as suspended particles. In order to remove the impurities, during the production of a polymerization toner, monomers are polymerized to form resinous particles, and subsequently, the resultant resinous particles are subjected to washing and filtration employing a filter. However, these drifting impurities are trapped with the resinous particles on the filter and are not usually discharged together with the filtrate. Namely, the impurities remain mixed in the toner after drying. As a result, it was discovered that the impurities cause problems such as insufficient charging, toner fusion onto structural members, and excessive staining.

The inventors of the present invention surveyed techniques known in the art, which related to the problems and found Japanese Patent Application Open to Public Inspection No. 2001-249490 which disclosed that a slurry was filtered and was re-dispersed (was subjected to re-slurrying). However, in this invention, filtration is only repeated employing a filter and the impurities are not effectively removed.

The present invention was achieved to overcome the aforesaid problems.

### SUMMARY OF THE INVENTION

An aspect of the present invention is to effectively remove the impurities in the toner so as to minimize background staining due to insufficient charging and to further minimize fusion of the toner onto an electrophotographic photoreceptor and staining (filming).

The inventors of the present invention performed diligent investigation to overcome the aforesaid problems. As a result, it was discovered that since the specific gravity of the aforesaid impurities was smaller than the toner, or the particle diameter was relatively small, the impurities could be skimmed together with the filtrate while utilizing differences in the sedimentation rate. As a result, sufficient charging was achieved and fusion to other members as well as staining did not occur, whereby the resultant electrophotographic characteristics were markedly improved. Accordingly, the present invention was achieved.

Namely, the present invention can be achieved the following structure.

A production method of electrostatic latent image developing toner, comprising: a step of forming colored particles in water-based medium; a first separation step of separating the colored particles from the water-based medium; a step of dispersing the colored particles into a washing medium; a step of skimming impurities other than the colored particles together with at least a part of the washing medium, the impurities drifting on the washing medium; and a step of drying the colored particle so as to make the water content of the colored particles being 3% or less.

### PREFERRED EMBODIMENTS OF THE INVENTION

In the production method of the present invention, a step which forms colored particles in a water-based medium is included. The process refers generally to the process which prepares resinous particles by polymerizing monomers in a water-based medium and, if necessary, prepares colored particles by aggregating and fusing the resultant resinous particles with colorant. However, in the present invention, a method may alternately be employed in which after preparing resin, the resultant resin is temporarily dried and is subjected to bulk, subsequently, colorants are added and kneaded, and the resultant mixture is subjected to particles which are dispersed into a water-based medium, whereby colored particles are formed. The essential point is that a process is included which forms colored particles in a water-based medium or in the water-based medium comprising surface active agents.

In order to conduct the step, a salting-out/fusion method is preferably employed. However, other than salting-out, aggregation may be carried out by employing heat or organic solvents. A method may also be employed in which, instead of simultaneously conducting salting-out and fusion, aggregation is completed by salting-out at temperatures lower or equal to the glass transition point and subsequently, aggregated particles are fused by heating.

Compounds, toner compositions, toner production methods, and employed devices, which are employed in the present invention, will now be described.

<Aggregation and Fusion Step>

The present invention preferably comprises a step of aggregating and fusing resinous particles in a dispersion containing a resinous particle, preferably in a dispersion of a resinous particles prepared by polymerization in a water-based medium. In the step, it is possible to use divalent through tetravalent metal salts as a preferable coagulant. The reason is that since the critical aggregation concentration (the aggregation value or aggregation point) of polyvalent metal salts is less than that of univalent metal salts, it is possible to decrease the addition amount.

The aggregation and fusion step, as described below, refers to a step in which resinous particles start aggregation in a dispersion comprised of a water-based medium and the particle diameter increases with time.

In aggregation and fusion of the present invention, it is preferable that, fusion (disappearance of interfaces between the particles) occurs simultaneously due to salting-out (aggregation of particles) or aggregation and fusion are allowed to occur as parallel processes. In order to have aggregation and fusion perform simultaneously, it is preferable to aggregate and fuse particles (composite resinous particles and colored particles) at temperatures higher or equal to the glass transition temperature (Tg) of the resin composing the composite resinous particle.

The fusion refers to the state in which the interfaces between resinous particles disappear, which can be confirmed by observing a slice employing a transmission type electron microscope.

In the aggregation and fusion process, internal additive particles (minute particles having a number average diameter of primary particles of about 10 to about 1,000 nm), such as charge control agents, may be aggregate fused together with composite resinous particles and colorant particles. Further, the colorant particles may be subjected to surface modification. Employed as surface modifiers may be any of those which are conventionally known in the art.

Further, in the present invention, resinous particles and colorant particles are aggregated and fused in a water-based medium to prepare colored particles (hereinafter occasionally referred to a toner or toner particles). Thereafter, it is preferable that the resultant toner particles be separated from the water-based medium at temperatures higher or equal to the Kraft point of surface active agents which are present in the water-based medium. It is more preferable that the separation be carried out in the temperature range of the Kraft point to the Kraft point plus 20° C.

The above-described Kraft point refers to temperature at which an aqueous surface active agent solution turns to milky-white. The Kraft point is determined as described below.

<<Determination of the Kraft Point>>

A solution is prepared by adding a coagulant in a practically used amount to a water-based medium employed in the aggregation and fusion process, namely a surface active agent solution. The resulting solution is stored at 1° C. for 5 days. Subsequently, while stirring, the resulting solution is gradually heated until it becomes transparent. The temperature, at which the solution becomes transparent, is defined as the Kraft point.

Specific examples of coagulants will now be listed.

Listed as divalent metal salts are magnesium chloride, calcium chloride, zinc chloride, copper sulfate, magnesium sulfate, and manganese sulfate. Listed as trivalent metal salts are aluminum chloride, aluminum hydroxide, aluminum sulfate, and iron chloride. Listed as tetravalent metal salts are titanyl sulfate and tin tetrachloride.

These are suitably selected based on their purposes. However, divalent or trivalent metal salts are preferred so that aggregation does not proceed abruptly but proceeds at an appropriate rate and the diameter of toner particles are easily controlled. Of these, preferably employed are divalent metal salts.

The above-described critical aggregation concentration is an index which relates to the stability of the dispersed product in a water-based dispersion. Practically, it refers to the concentration of an added coagulant, which results in aggregation. The critical aggregation concentration greatly varies depending on the resinous particles themselves, as well as added coagulants.

It is possible to determine the critical aggregation concentration, employing a method described, for example, in Seizoh Okamura et al., Kohbunshi Kagaku (Polymer Chemistry) 17, 601 (1960). Further, another method may be employed to determine the critical aggregation concentration in which the specified salt is added to the particle dispersion to be measured while varying the salt concentration; subsequently, the ζ potential of the resulting dispersion is determined; and the salt concentration at which the ζ potential begins to vary is designated as the critical aggregation concentration.

In the present invention, resinous particle dispersion is treated by the coagulants so as to result in at least the critical aggregation concentration. In such a case, needless to say, the direct addition of the coagulant in the form of powder or the addition of the coagulant in the form of a solution is optionally selected depending on their purpose. When added in the form of an aqueous solution, it is necessary to add the coagulant to be more than or equal to the critical aggregation concentration with respect to the total volume of the resinous particle dispersion and the aqueous coagulant solution.

In the present invention, it is acceptable that the concentration of the coagulant is more than or equal to the critical aggregation concentration. However, it is preferable that the coagulant is added so as to be at least 1.2 times the critical aggregation concentration, but it is more preferable that the coagulant is added so as to be at least 1.5 times.

<Aggregation Terminating Agents and Particle Growth Termination Step>

Aggregation terminating agents refer to compounds which result in less aggregation force of resinous particles during salting-out, in case it is employed together with metal salts employed as a coagulant (two types of metal ions or a metal-free positive ion exist in the resinous particle dispersion), than the case in which the metal salts are employed, singly. Specific examples include a salt which has a different positive ion valence with respect to the coagulant or salts which have the same valence but the different positive ion radius. In the present invention, it is preferable that salts, which have a lower positive ion valence than the coagulants, are employed.

Conventionally, the growth of aggregation particles, which are assumed to form toner particles, has been terminated by dilution such as the addition of a large amount of water, without using the aggregation terminating agents. However, it is possible to quickly terminate the growth by employing the aggregation terminating agents. As a result, it has become possible to prepare toner particles having fewer coarse particles, namely having a narrower particle size distribution.

The inventors of the present invention discovered that when there were the aforesaid two types of positive ions during the aggregation and fusion step, the aggregation rate of resinous particles markedly decreased instead of resulting in the intermediate rate. As a result, it was found that it was possible to apply the phenomena to the growth termination of aggregated and fused particles. The mechanism is not yet fully understood. However, it is assumed that the phenomena are due to antagonism between positive ions.

Listed as univalent metal salts, usable as an aggregation terminating agent, are sodium chloride, potassium chloride, and lithium chloride. Other than metal salts, it is possible to employ ammonium salts such as ammonium chloride. Employed as divalent and trivalent metal salts may be those which are the same as used for coagulants.

Table 1 shows examples of preferred combinations of the coagulants and the aggregation terminating agents, depending on the valence value.

TABLE 1

| | | Aggregation |
|---|---|---|
| | Coagulant | Terminating Agent |
| Particularly | divalent metal salt | univalent metal salt |
| Preferred | | |
| Preferred | trivalent metal salt | divalent metal salt |
| Other | trivalent metal salt | univalent metal salt |
| Embodiments | divalent metal salt | univalent ammonium |
| | salt | |
| | tetravalent metal salt | trivalent metal salt |
| | tetravalent metal salt | divalent metal salt |
| | tetravalent metal salt | univalent metal salt |

In the present invention, particle growth, which proceeds during the aggregation and fusion step, is terminated during the particle growth termination step during which aggregation terminating agents are added. However, the growth may not be totally terminated. It is acceptable that the growth is merely retarded.

When the toner particle diameter increases from 80 to 120 percent, with respect to the final diameter, the aggregation terminating agents are added. When the diameter increases from 90 to 110 percent, the aggregation terminating agents are preferably added. Specifically, when, for instance, toner particles, having a volume average particle diameter of 5 μm, are to be prepared, addition is preferably carried out when the particle diameter of coalesced particles increases from 4 to 6 μm. More preferably addition is carried out when the diameter increases from 4.5 to 5.5 μm.

After adding the aggregation terminating agents, the particles occasionally grow slightly or the determined particle diameter decreases depending on the variation of the particle shape due to continuous stirring. However, the desired reproduction of the average particle diameter can be obtained when the aggregation terminating agents are added in the aforesaid range.

The volume average particle diameter, as described in the present invention, refers to the diameter determined by a Coulter Multisizer (manufactured by Coulter, Inc.), or FPIA-2000 (manufactured by Sysmec Co.).

The adding amount of coagulants and aggregation terminating agents may be adjusted depending on the valence of each type of agent. It is preferable that the coagulants and aggregation terminating agents are added in the form of an aqueous solution. However, they may also be added in the form of a powder.

The production method of the present invention comprising a first separation step to separate the colored particles from the water-based medium after forming colored particles. The first separating step represents not only to separate the colored particles from the water-based medium clearly, but also to collect colored particles employing devices such as a centrifuge upon concentrating the colored particles in the water-based medium, though the colored particles are not definitely separated from the water-based medium.

<Washing and Removing Step>

After a dispersing step in which colored particles are dispersed in a washing medium, the skimming step to skim impurities drifting on the washing medium other than the colored particles together with at least a part of the washing medium is performed.

In the skimming step of the present invention, a centrifugal method is preferably employed to divide the colored particles and the impurities. Specifically, the dispersion dispersed therein the colored particles and the impurities is subjected to the centrifugal method and the colored particles are let down in the dispersion. Subsequently, supernatant liquid of the dispersion containing the impurities is removed by decantation. In this method, the colored particles and the impurities can be effectively separated by utilizing the difference of sedimentation rate between the colored particles and the impurities. Especially, a usual releasing agent remains in the supernatant liquid and can be skimmed easily since the specific gravity of the releasing agent is relatively small.

As the condition of the centrifugal method in the skimming step, the acceleration of the centrifugal method is preferably 50 to 800 G, and more preferably 200 to 800 G. When the centrifugal method is utilized to divide the colored particle and the impurities in the dispersion, a vessel having a closed bottom is preferably employed. If such as a filter is used as the bottom of the vessel, the drifting impurities cannot be skimmed effectively since the liquid in the dispersion flows out. As the bottom of the vessel for the centrifugal method in the skimming step, an opening-and-closing structure is preferable to recover the submerged colored particles, easily. If the acceleration of the centrifugal method is too small, the colored particles cannot be let down, effectively. On the other hand, if the acceleration of that is too high, skimming the impurities becomes difficult since both of the impurities and the colored particles settles down.

Subsequently, The colored particles preferably enter a step in which they are separated from the resulting dispersion (also referred as to a second separation step). As a separation method, such as a centrifugal method is employed. The water proportion of toner particles (as a wet cake), after the separation step, is preferably from 10 to 50 percent. Specifically, the slurry containing colored particles subjected to the above skimming step is placed in the tank of a centrifuge fitted with a tube-shaped filter cloth. Upon energizing the centrifuge, a wet cake of the colored particles is formed in the interior of the filter cloth and the wet cake is washed by supplying water to the tank of the centrifuge.

The washing/separation step is carried out so that the electroconductivity of the filtrate is commonly at most 50 μS/cm, is preferably at most 30 μS/cm, and is more preferably at most 20 μS/cm. When the electroconductivity of the filtrate exceeds 50 μS/cm, the residual amount of impurities, such as surface active agents, is excessive. As a result, when the resulting toner is employed at high temperature and high humidity, sharp images are occasionally not obtained due to the formation of background staining.

The electroconductivity of the filtrate can be determined by common electroconductivity meters. Listed as one of the electroconductivity meters is “CM-14P”, manufactured by DKK TOA Corp.

The filter cloth employed for centrifugal separation is not particularly limited. However, it is preferable that the wet cake can be efficiently secured and water can smoothly flow out.

Water employed as a washing medium is not particularly limited. It is possible to employ, for example, well water, city water and deionized water. However, in order to achieve the electroconductivity of a filtrate of less than or equal to 50 μS/cm, it is preferable to finally use water having a low electroconductivity of less than or equal to 10 μS/cm.

Acceleration of centrifugal separation during the washing/separation step is preferably from 500 to 1,000 G, and is more preferably from 600 to 800 G. When the acceleration is less than 500 G, it becomes difficult to uniformly supply washing water to all parts of the entire wet cake, formed on the filter cloth and comprising the colored particles. As a result, even though the electroconductivity of the filtrate is less than or equal to 50 μS/cm, occasionally impurities may remain locally. On the other hand, when the acceleration exceeds 1,000 G, cracks form on the surface of the wet cake comprising the colored particles. As a result, washing water flows from the cracks whereby it occasionally becomes difficult to sufficiently remove impurities such as surface-active agents and coagulants.

Incidentally, in the dispersing step, the weight of washing medium is preferably from 10 to 100 times with respect to the weight equivalent to solid content of colored particles. Further, it is preferable that in either the first separation step or the second separation step, colored particles are separated from water-based medium or washing medium, employing centrifugal separation.

Further, it is preferable to put into practice a method in which while, in either the first or second separating step, when filtering colored particles from water-based medium or washing medium employing centrifugal separation, filtration is completed after pouring fresh washing medium onto colored particles which remain in the filter. Further, it is preferable that after the drying step, colored particles are re-dispersed into the washing medium and re-filtered, and filtration is completed after pouring fresh washing medium onto colored particles which remain in the filter. By putting into practice these treatments, it is possible to completely remove suspended particles which tend to result in background staining as well as toner filming.

The supply amount of water for washing is typically from 0.05 to 10.00 liters/minute per kg of the solid, and is most preferably from 0.1 to 5.0 liters/minute.

When the supply amount of water is excessively small, washing is not effectively carried out. As a result, even though the conductivity of the filtrate exhibits a low value, impurities such as surface-active agents as well as coagulants tend to remain. On the other hand, when the supply amount is excessively large, washing is efficiently carried out. However, since water is retained in the centrifuge, impurities such as surface-active agents as well as coagulants, which have temporarily separated from the colored particles, are re-adhered onto the colored particles. As a result, the impurities tend to remain on the colored particles.

4. Drying Step

The drying step is the step which dries toner particles (colored particles) which have been subjected to the washing treatment.

Listed as dryers employed in the process are spray driers, vacuum freeze driers, and decompression driers. It is also preferable to use standing shelf driers, moving type shelf driers, fluid bed driers, rotary type driers, and stirring type driers.

The moisture content of colored particles, which have been subjected to a drying treatment, is preferably at most 3 percent by weight, and is more preferably at most 2 percent by weight.

Incidentally, when colored particles, which have been subjected to the drying treatment, aggregate employing the weak attractive force between particles, the aggregation body may be subjected to a pulverizing treatment. Employed as pulverizing treatment devices are mechanical pulverization devices such as a jet mill, a Henschel mixer, a coffee mill, or a food processor.

<Surface Active Agents>

Anionic surface active agents are preferably incorporated in a water-based medium in which resinous particles grow through aggregation and fusion. Anionic surface active agents, and nonionic surface active agents or cationic surface active agents may be employed in combination. However, when only anionic surface active agents are incorporated, it is possible to very accurately control the particle diameter. The anionic surface active agents may be carried in from a resinous particle dispersion or may be newly added during the aggregation and fusion step.

<Production Method of Resinous Particles>

In the most representative production method, resinous particles are prepared by polymerizing polymerizable monomers in a water based medium in the production method, fine resinous particles are prepared by emulsion-polymerizing monomers in a medium (usually a water-based medium) to which an emulsified composition, comprising necessary additives, or by carrying out mini-emulsion polymerization. If desired, colorants, fixing improving agents such as release agents, and charge control agents, are added. Subsequently, aggregation and fusion are carried out by adding the aforesaid coagulants, such as salts.

One example of the method for producing the toner of the present invention is as follows. Various types of components such as colorants, and if desired, release agents, and polymerization initiators are added into polymerizable monomers, and subsequently, the various types of components are dissolved in or dispersed into the polymerizable monomers, employing a homogenizer, a sand mill, a sand grinder, or an ultrasonic homogenizer. The resulting monomers, which comprise dissolved or dispersed components, are dispersed into a water-based medium, employing a homomixer or a homogenizer so as to form oil droplets, having the specified size as toner particles.

Thereafter, the resulting dispersion is placed in a reaction apparatus (being a stirring apparatus), which is fitted with stirring mechanisms, which refer to the stirring blade described below, and undergoes reaction while being heated. As a result, fine resinous particles are prepared. Subsequently, the aforesaid coagulants such as salts are added and the resinous particles are aggregated and fused. Thereafter, the resulting toner particles are separated, washed, the impurities in the toner particles are removed, and dried, whereby the toner of the present invention is prepared. Incidentally, as used herein, the term “water-based medium” is used to refer to a medium which is comprised of at least 50 percent of water by weight.

Further, listed as a method for producing the toner of the present invention may be a method in which resinous particles are prepared employing an emulsion polymerization method and the resulting particles are aggregated and fused. There is no limitation for the method. However, listed as methods may be those described, for example, in Japanese Patent Application Open to Public Inspection Nos. 5-265252, 6-329947, and 9-15904.

Thereafter, as previously described, resinous particles and constituting materials, such as colorants, are aggregated and fused, and subsequently, heated to a temperature higher or equal to the glass transition point so as to be fused. The preferable processes are as follows. The resulting particles are dispersed in water, employing emulsifiers. Thereafter, the resulting dispersion is salted out by adding coagulants in an amount of at least the critical aggregation concentration. The resulting polymer is heated to higher or equal to the glass transition temperature, and preferably, the particle size is allowed to gradually increase. When the particle size reaches the specified value, the aforesaid aggregation terminating agents are added so as to terminate an increase in particle size. Further, during heating and stirring, the particle surface is smoothed and the particle shape is controlled. Subsequently, the resulting particles are separated from the dispersion and heat dried, whereby it is possible to form the toner of the present invention. Incidentally, herein, in order to efficiently proceed with fusion, solvents such as alcohols, which are infinitely soluble in water, may be simultaneously added.

Further, in the production method of the toner of the present invention, it is preferable that fine composite resinous particles, which are prepared employing a multiple stage polymerization method, and fine colorant particles are aggregated and fused. The multiple stage polymerization is

(Production Method of Composite Resinous Particles Prepared by a Multiple Stage Polymerization Method)

The production method of the toner of the present invention is preferably comprised of the processes described below.

The multiple stage polymerization method, as described herein, refers to the polymerization method which expands the molecular weight distribution of resinous particles to prepare toner capable of minimizing offsetting. Namely, in order to form phases having different molecular weight distributions in one resinous particle, polymerization reaction is carried out while dividing into multiple stages so that in the resulting resinous particle, the molecular weight gradient is formed from the center of the particle to its surface layer. For example, a method is employed in which after preparing a dispersion comprised of high molecular weight resinous particles, a low molecular weight surface layer is formed by newly adding polymerizable monomers as well as chain transfer agents.

In the present invention, from the viewpoint of the production stability and improved crushing resistance of the resulting toner, it is preferable to employ the multiple stage polymerization method comprised of at least three stages. Two-stage and three-stage polymerization methods, which are representative examples of the multiple stage polymerization method, will now be described. In toner which is prepared by such a multiple stage polymerization reaction, from the viewpoint of the crushing resistance, it is preferable that resins having a lower molecular weight are increasingly employed while approaching the surface layer.

<Two-Stage Polymerization Method>

The two-stage polymerization method is a method to prepare composite resinous particles which are comprised of a central portion (being a nucleus) comprised of high molecular weight resins comprising crystalline materials and an outer layer (being a shell) comprised of low molecular weight resins.

This method will now be specifically described. Initially, a monomer solution is prepared by dissolving crystalline materials in monomers. After dispersing the resulting monomer solution into a water-based medium (for example, an aqueous surface active agent solution) so as to form oil droplets, the resulting system is subjected to a polymerization treatment (the first stage polymerization), whereby a dispersion of high molecular weight resinous particles, containing crystalline materials is prepared.

Subsequently, polymerization initiators and monomers to prepare low molecular weight resins are added to the resulting resinous particle dispersion, and the monomers undergo polymerization (the second stage polymerization) in the presence of the resinous particles, whereby a covering layer, comprised of the low molecular weight resins (the polymers of monomers), is formed.

<Three-Stage Polymerization Method>

The three-stage polymerization method is a method to prepare composite resinous particles which are comprised of a central portion (being a nucleus) comprised of high molecular weight resins, an interlayer comprising crystalline materials and an outer layer (being a shell) comprised of low molecular weight resins. The toner particle of the present invention is formed as the composite resinous particle.

This method will now be specifically described. Initially, a dispersion comprised of resinous particles, which have been prepared by polymerization (the first stage polymerization) according to a conventional method, is added to a water-based medium (for example, an aqueous surface active agent solution). After dispersing a monomer solution, prepared by dissolving crystalline materials in monomers, into the water-based medium so as to for-cm oil droplets, the resulting system undergoes polymerization (the second stage polymerization), whereby a covering layer (an interlayer) comprised of resins, containing crystalline materials, is formed on the surface of resinous particles (nucleus particles). Thus a composite resinous particle (comprised of high molecular weight resins and intermediate molecular weight resins) dispersion is prepared.

Subsequently, polymerization initiators and monomers to prepare a low molecular weight resin are added to the resulting composite resinous particle dispersion, and the monomers undergo polymerization (the third stage polymerization) in the presence of the composite resinous particles, whereby a covering layer comprised of a low molecular weight resin (a polymer of the monomers) is formed. In the aforesaid method, it is preferable to include an interlayer because it is possible to uniformly disperse crystalline materials so as to form minute particles.

The preferable production method of the toner according to the present invention is characterized in that polymerizable monomers are polymerized in a water-based medium. Namely, the method is such that during formation of nucleus particles or the covering layer (the interlayer), resinous particles are prepared by dispersing a monomer solution into a water-based medium so as to form oil droplets, and finally carrying out polymerization by adding polymerization initiators to the resulting system.

The water-based media, as described in the present invention, refer to media comprised of water in an amount of 50 to 100 percent by weight and water-soluble organic solvents in an amount up to 50 percent by weight. Exemplified as water-soluble solvents may be, for example, methanol, ethanol, isopropanol, butanol, acetone, methyl ethyl ketone, and tetrahydrofuran. Of these, preferred are alcohol based organic solvents, which do not dissolve the prepared resins.

The diameter of the composite resinous particles prepared by the polymerization process is the weight average particle diameter, determined employing an Electrophoretic Light Scattering Spectrophotometer “ELS-800” (manufacture by Ohtsuka Denshi Co. Ltd.), and is preferably in the range of 10 to 1,000 nm.

Further, the glass transition temperature (Tg) of the composite resinous particles is preferably in the range of 40 to 74° C., and is more preferably in the range of 42 to 64° C.

Still further, the softening pint of the composite resinous particles is preferably in the range of 95 to 140° C.

From the viewpoint of retarding excessive charging applied to toner particles as well as of providing uniform chargeability, particularly in order to stabilize the chargeability against ambience and to maintain the chargeability, the electrostatic latent image developing toner of the present invention comprises, as the aforesaid coagulant and aggregation terminating agent, metal elements (listed are metals and metal ions) preferably in an amount of 250 to 20,000 ppm in the toner and more preferably in an amount of 800 to 15,000 ppm.

Still further, in the present invention, the total added amount of metal elements and aggregation terminating argents, such as univalent metals, is preferably from 350 to 35,000 ppm, in terms of those chlorides.

It is possible to determine the residual metal ion amount in toner by measuring fluorescent X-ray intensity emitted from metals (for example, calcium in calcium chloride) of metal salts, employing a fluorescent X-ray analyzer “System 3270 type” (manufactured by Rigaku Denki Kogyou Co.).

A specific measurement method is as follows. A plurality of toners, of which content ratio of a coagulant metal salt is known, is prepared. Subsequently, 5 g of each toner is pelletized and the relationship (a calibration curve) between the content ratio (in ppm by weight) of the coagulant metal salt and the fluorescent X-ray intensity emitted from the metal of the metal salt is determined. Subsequently, toner (a sample), of which content ratio of the coagulant metal salt is to be determined, is pelletized in the same manner and the fluorescent X-ray intensity emitted from the metal of the coagulant metal salt is determined, whereby it is possible to determine the content ratio, namely “the residual amount of the metal ions in the toner”.

The toner of the present invention is most preferably prepared as described below. Composite resinous particles are formed in the absence of colorants. Thereafter, the colorant particle dispersion is added to the composite resinous particle dispersion. Subsequently, the toner is prepared by aggregating and fusing the composite resinous particles and colorant particles.

As previously described, by preparing the composite resinous particles in a system comprised of no colorants, polymerization reaction to prepare composite resinous particles is not hindered.

Polymerization reaction to prepare the composite resinous particles is assuredly carried out. As a result, monomers as well as oligomers do not remain in the resulting toner and employing the toner, no unpleasant odors are generated during the thermal fixing process of the image forming method.

Furthermore, the resulting toner particles exhibit uniform surface characteristics as well as a narrow charge amount distribution. As a result, it is possible to produce images with excellent sharpness over a long period of time. By employing a toner exhibiting such uniform composition, molecular weight and surface characteristics among toner particles, in the image forming method comprising a fixing process, employing a contact heating system, it is possible to improve offsetting resistance and winding resistance while maintaining excellent adhesive properties (high fixing strength) with respect to the image support, and in addition, it is possible to produce images exhibiting appropriate glossiness. Further, the residual toner on the photoreceptor can be removed, as desired.

Each of composition elements employed in the toner production processes will now be detailed.

<Polymerizable Monomers>

Employed as polymerizable monomers to prepare resins (binders), employed in the present invention, are hydrophobic monomers as an essential composition element and if desired, crosslinkable monomers. Further, it is preferable that at least one kind of monomers having an acidic polar group or a basic polar group in the structure, as shown below, is incorporated.

(1) Hydrophobic Monomers

Hydrophobic monomers, which constitute a monomer component, are not particularly limited, and conventional monomers known in the art may be employed. Further, the monomers may be employed individually or in combination of at least two types so as to realize desired characteristics.

Specifically employed may be monovinyl aromatic based monomers, (meth)acrylic acid ester based monomers, vinyl ester based monomers, vinyl ether based monomers, monoolefin based monomers, diolefin based monomers, or halogenated olefin based monomers.

Listed as vinyl aromatic based monomers may be, for example, styrene based monomers such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrne, and 3,4-dichlorostyrne, and derivatives thereof.

Listed as (meth)acrylic acid ester based monomers my be acrylic acid, methacrylic acid, methyl acrylate, ethyl acrylate, butyl acrylate, acrylic acid-2-ethylhexyl, cyclohexyl acrylate, phenyl acrylate, methyl methacrylate, ethyl methacrylate, butyl methacrylates, hexyl methacrylates, methacrylic acid-2-ethylhexyl, ethyl β-hydroxyacrylate, propyl γ-aminoacrylate, stearyl methacrylates, dimethyl aminoethyl methacrylates, and diethyl aminoethyl methacrylate.

Listed as vinyl ester based monomers may be vinyl acetate, vinyl propionate, and vinyl benzoate, while listed as vinyl ether monomers may be vinyl methyl ether, vinyl ethyl ether, vinyl isobutyl ether, and vinyl phenyl ether.

Further, listed as monoolefin based monomers may be ethylene, propylene, isobutylene, 1-butene, 1-pentene, and 4-methyl-1-pentene, while listed as diolefin based monomers ma be butadiene, isoprene, and chloroprene.

(2) Crosslinkable Monomers

In order to improve the characteristics of resinous particles, crosslinkable monomers may be incorporated. Listed as crosslinkable monomers are, for example, monomers such as divinylbenzne, divinylnaphthalene, divinylether, diethylene glycol methacrylate, ethylene glycol methacrylate, polyethylene glycol dimethacrylate, and diallyl phthalate, all of which have at least two unsaturated bonds.

(3) Monomers having an Acidic Polar Group

Listed as monomers having an acidic polar group may be (a) α,β-ethylenic unsaturated compounds having a carboxylic group (—COOH) and α,β-ethylenic unsaturated compounds having a sulfonic group (—SO₃H).

(a) Listed as examples of α,β-ethylenic unsaturated compounds having a carboxylic group may be acrylic acid, methacrylic acid, fumaric acid, maleic acid, itaconic acid, cinnamic acid, monobutyl maleate, monooctyl maleate, and metal salts thereof, such as Na salts and Zn salts.

(b) Listed as examples of α,β-ethylenic unsaturated compounds having a sulfonic group may be sulfonated styrene and Na salts thereof, and allylsulfosuccinic acid and octyl allylsulfosuccinate and Na salts thereof.

(4) Monomers having a Basic Polar Group

Demonstrated as monomers having a basic polar group may be (i) (meth)acrylic acid esters of aliphatic alcohols, having an amine group or a quaternary ammonium group, which have from 1 to 12 carbon atoms, preferably from 2 to 8 carbon atoms, and more preferably 2 carbons atoms, (ii) (meth)acrylic acid amides or (meth)acrylic acid amides which are subjected to mono or di-substitution on optional carbon atom(s) with an alkyl group having from 1 to 18 carbon atoms, (iii) vinyl compounds substituted with a heterocyclic group having N as a ring member, and (iv) N,N-diallyl-alkylamines or quaternary ammonium salts thereof. Of these, preferred as monomers having a basic polar group are (meth)acrylic acid esters of aliphatic alcohols having an amine group or a quaternary ammonium group of (i).

(i) Listed as examples of (meth)acrylic acid esters of aliphatic alcohols having an amine group or a quaternary ammonium salt may be dimethyl aminoethyl acrylate, dimethyl aminoethyl methacrylate, diethyl aminoethyl acrylate, diethyl aminoethyl methacrylate, quaternary ammonium salts of the four compounds, 3-dimethylaminophenyl acrylate, and 2-hydroxy-3-methacryloxypropyltrimethl ammonium salt.

(ii) Listed as (meth)acrylic acid amides which are subjected to mono- or di-substitution on optional carbon atom(s) with an alkyl group may be acrylamide, N-butylacrylamide, N,N-dibutylacrylamide, piperidylacrylamide, methacrylamide, N-butylmethacrylamide, N,N-dimethylacrylamide, and N-octadecylacrylamide.

(iii) Listed as vinyl compounds substituted with a heterocyclic group having N as a ring member may be vinylpyridine, vinylpyrrolidone, vinyl-N-methylpyridinium chloride, and vinyl-N-ethylpyridinium chloride.

(iv) Listed as examples of N,N-diallyl-alkylamines may be N,N-diallylmethylammonium chloride and N,N-diallylammonium chloride.

In the present invention, radical polymerization initiators may suitably be employed, as long as they are water-soluble. Listed as those are, for example, persulfates (for example, potassium persulfate and ammonium persulfate, azo based compounds (for example, 4,4-azobis-4-cyanovaleric acid and salts thereof), and peroxide compounds. Further, if desired, the radical polymerization initiators may be combined with reducing agents so as to be used as a redox system initiator. The use of the redox system initiators results in advantages such as an increase in polymerization activity, a decrease in polymerization temperatures, and a decrease in polymerization time.

Polymerization temperatures are not particularly limited, as long as they are higher or equal to the minimum radical formation temperature of the polymerization initiator, and are, for example, in the range of 50 to 90° C. However, by employing polymerization initiators comprised of a hydrogen peroxide-reducing agent (such as ascorbic acid) combinations, which are capable of initiating polymerization at room temperature, it is possible to carry out polymerization at room temperature or higher.

(Chain Transfer Agents)

For the purpose of adjustment of molecular weights, it is possible to use chain transfer agents, known in the art. The chain transfer agents are not particularly limited. Employed as the transfer agents are compounds having a mercapto group, such as octylmercaptan, dodecylmercaptan, and tert-dodecylmercaptan. Compounds having a mercapto group are preferably employed, since unpleasant odors during thermal fixing are minimized; toner having a narrow molecular weight distribution can be produced; and excellent storage stability, fixing strength, and offsetting resistance are obtained. Listed as preferred compounds may be propyl thioylycolate, butyl thioglycolate, t-butyl thioglycolate, 2-ethylhexyl thioglycolate, octyl thioglycoate, decyl thioglycolate, dodecyl thioglycolate, ethylene glycol having a mercapto group and derivatives thereof; neopentyl glycol having a mercapto group and derivatives thereof; and pentaerythritol having a mercapto group and derivatives thereof. Of these, from the viewpoint of minimizing unpleasant odors during thermal fixing of toner, n-octyl-3-mercaptopropionic acid esters are particularly preferred.

<Surface Active Agents>

In order to carry out mini-emulsion polymerization employing the aforesaid polymerizable monomers, it is preferable that oil droplet dispersion is carried out in a water-based medium, employing surface active agents. Surface active agents usable for the dispersion are not particularly limited, however, it is possible to list ionic surface active agents as examples of suitable compounds.

Listed as ionic surface active agents are, for example, sulfonates (sodium dodecylbenzenesulfonate, sodium arylalkylpolyethersufonate, sodium 3,3-disulfonedophenylurea-4,4-diazo-bis-amino-8-naphthol-6-sulfonate, ortho-carboxybenzene-azo-dimethylaniline, and sodium 2,2,5,5-tetramethyl-triphenylmethane-4,4-diazo-bis-p-naphthol-6-sulfonate), sulfuric acid ester salts (sodium dodecylsulfonate, sodium tetradecylsulfonate, sodium pentadecylsulfonate, and sodium octylsulfonate), and aliphatic acid salts (sodium oleate, sodium laurate, sodium caprate, sodium caprylate, sodium caproate, potassium stearate, and calcium oleate).

In the present invention, surface active agents represented by General Formulas (1) and (2), described below, are particularly preferable.

R¹(OR²)ₙOSO₃M General Formula (1)

R¹(OR²)ₙSO₃M General formula (2)

In General Formulas (1) and (2), R¹ is an alkyl group having from 6 to 22 carbon atoms or an arylalkyl group, is preferably an alkyl group having from 8 to 20 carbon atoms or an arylalkyl group, and is more preferably an alkyl group having from 9 to 16 carbon atoms or an arylalkyl group.

Listed as alkyl groups having from 6 to 22 carbon atoms, represented by R¹ are, for example, an n-hexyl group, an heptyl group, an n-octyl group, an n-decyl group, an n-undecyl group, an n-hexadecyl group, a cyclopropyl group, a cyclopentyl group, and a cyclohexyl group, and listed as arylalkyl groups represented by R¹ are a benzyl group, a diphenyl group, a cinnamyl group, a styryl group, a trityl group, and a phenetyl group.

In General Formulas (1) and (2), R² is an alkylene group having from 2 to 6 carbon atoms, and is a preferably an alkylene group having from 2 or 3 carbon atoms. Listed as alkylene groups having from 2 to 6 carbon atoms, represented by R² are an ethylene group, a trimethylene group, a tetramethylene group, a propylene group, and an ethylethylene group.

In General Formulas (1) and (2), n is commonly an integer of 1 to 11, is preferably from 2 to 10, is more preferably from 2 to 5, and is still more preferably 2 or 3.

In General Formulas (1) and (2), listed as univalent metals represented by M are sodium, potassium, and lithium. Of these, sodium is preferable.

Specific examples of surface active agents represented by General formulas (1) and (2) will now be demonstrated. However, the present invention is not limited to these examples.

C₁₀H₂₁(OCH₂CH₂)₂OSO₃Na Compound (101)

C₁₀H₂₁(OCH₂CH₂)₃OSO₃Na Compound (102)

C₁₀H₂₁(OCH₂CH₂)₂OS₃Na Compound (103)

C₁₀H₂₁(OCH₂CH₂)₃S₃Na Compound (104)

C₈H₁₇(OCH₂CH(CH₃))₂SO₃Na Compound (105)

C₁₈H₃₇(OCH₂CH₂) OSO₃Na Compound (106)

From the viewpoint of maintaining the charge bearing function of toner at a desired state, minimizing background staining at high temperature and high humidity, and enhancing transferability, as well as from the viewpoint of retarding an increase in the charge amount at low temperature and low humidity, and stabilizing the development amount, the content of the surface active agents represented by aforesaid General Formulas (1) and (2), in an electrostatic latent image developing toner, is preferably from 1 to 1,000 ppm, is more preferably from 5 to 500 ppm, and is most preferably from 7 to 100 ppm.

In the present invention, by adjusting the amount of surface active agents, incorporated in toner, to the aforesaid range, it is possible to always provide and maintain uniform chargeability of the electrostatic latent image developing toner of the present invention, without being affected by existing ambience.

Further, the content of surface active agents represented by aforesaid General Formulas (1) and (2), which are incorporated in the electrostatic latent image developing toner of the present invention, is determined by the method described below.

Dissolved in 50 ml of chloroform is 1 g of toner. Subsequently, surface active agent(s) are extracted from the chloroform layer, employing 100 ml of deionized water. Further, the chloroform layer, which has been subjected to extraction, is repeatedly subjected to extraction, employing 100 ml of deionized water, whereby 200 ml of the extract (being an aqueous layer) is obtained. The resulting extract is diluted to 500 ml.

The resulting diluted solution is employed as a sample solution which is subjected to coloration employing Methylene Blue, based on the method specified in JIS K 3363 Item 5. The absorbance of the resulting colored solution is determined, and the content of surface active agents(s) in the toner is determined, employing a calibration curve which has been independently prepared.

The structure of the surface active agent represented by General Formulas (1) and (2) was analyzed and determined employing a 1H-NMR.

Further, in the present invention, it is possible to employ nonionic surface active agents, which specifically include polyethylene oxide, polypropylene oxide, combinations of polypropylene oxide and polyethylene oxide, esters of polyethylene glycol with higher fatty acids, alkylphenol polyethylene oxide, esters of higher fatty acid with polyethylene glycol, esters of higher fatty acids with polypropylene oxides, and sorbitan esters.

In the present invention, these surface active agents are employed mainly as an emulsifier during emulsion polymerization. However, they may be employed in other processes or for other purposes.

<Resinous Particles and Molecular Weight Distribution of Toner Particles>

It is preferable that the peak or shoulder of the molecular weight distribution is in the range of 100,000 to 1,000,000 and 1,000 to 50,000. Further, it is more preferable that the peak or shoulder of the peak is in the range of 100,000 to 1,000,000, 25,000 to 150,000, and 1,000 to 50,000.

It is preferable that resins are comprised of high molecular weight components having a molecular weight peak or shoulder in the range of 100,000 to 1,000,000 and low molecular weight components having a molecular weight peak or shoulder in the range of 1,000 to 50,000. It is more preferable to use intermediate molecular weight resins having a peak or shoulder in the range of 15,000 to 100,000.

The molecular weight of the aforesaid toner or resins is preferably determined employing GPC (gel permeation chromatography) in which THF (tetrahydrofuran) is employed as a solvent. Namely, 0.5 to 5.0 mg of a measured sample, or specifically 1.0 mg of the sample, is added to 1 mg of THF, and is completely dissolved at room temperature while employing a stirrer such as a magnetic stirrer. Subsequently, the resulting solution is treated employing a membrane filter with a pore size of 0.45 to 0.50 μm, and is then injected into GPC. Measurement conditions of GPC are as follows. A column is stabilized at 40° C. THF is then flowed at a rate of 1.0 ml per minute and measurement is carried out by injecting 100 μl of a sample at a concentration of 1 mg/ml. Commercially available polystyrene gel columns are preferably employed upon being combined. For example, listed may be combinations of Shodex GPC KF-801, -802, -803, -804, -805, -806, and -807, manufactured by Showa Denko Co., as well as combinations of TSK-GEL G1000H, G2000H, G3000H, G4000H, G5000H, G6000H, and G7000H, and a TSK guard column, manufactured by Tosoh Corp. Further, it is preferable to use a refractive index detection apparatus (an IR detection apparatus) or a UV detection apparatus. During the measurement of the molecular weight of the sample, the molecular weight distribution of the sample is determined employing a calibration curve which has been prepared by employing standard monodispersed polystyrene particles. It is preferable that the calibration curve be drawn employing 10 differing polystyrene particle sizes.

<Colorants>

The toner of the present invention is preferably prepared by aggregating and fusing the aforesaid composite resinous particles and colorant particles. Listed as colorants (colorant particles which are aggregated and fused with the composite resinous particles) may be various types of inorganic pigments, organic pigments, and dyes. Employed as inorganic pigments may be those conventionally known in the art. Specific inorganic pigments are exemplified below.

Employed as black pigments are, for example, carbon blacks such as furnace black, channel black, acetylene black, thermal black, and lamp black, as well as magnetic powders such as magnetite and ferrite.

If desired, these inorganic pigments may be employed individually or in combination of a plurality of selected ones. The added amount of these pigments is typically from 2 to 20 percent by weight, and is preferably from 3 to 15 percent.

When employed as magnetic toner, the aforesaid magnetite may be incorporated. In such cases, from the viewpoint of providing the specified magnetic characteristics, it is preferable that the magnetite be incorporated in the toner in an amount of 20 to 60 percent by weight.

Employed as organic pigments as well as dyes may be those which are conventionally known in the art. Specific examples of organic pigments and dyes are cited below.

Listed as pigments for magenta or red are, for example, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48 : 1, C.I. Pigment Red 53 : 1, C.I. Pigment Red 57 : 1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Listed as pigments for orange or yellow are, for example, C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155, and C.I. Pigment Yellow 156.

Listed as pigments for green or cyan are, for example, C.I. Pigment Blue 15, C.I. Pigment Blue 15 : 2, C.I. Pigment Blue 15 : 3, C.I. Pigment Blue 16, C.I. Pigment Blue 60, and C.I. Pigment Green 7.

Further, employed as dyes may be, for example, C.I. Solvent Red 1, the same 49, the same 52, the same 58, the same 63, the same 111, and the same 122; C.I. Solvent Yellow 19, the same 44, the same 77, the same 79, the same 81, the same 82, the same 93, the same 98, the same 103, the same 104, the same 112, and the same 162; and C.I. Solvent Blue 25, the same 36, the same 60, the same 70, the same 93, and the same 95. In addition, mixtures thereof may also be employed.

If desired, these pigments as well as these dyes may be employed individually or in combination of a plurality of selected ones. Further, the added amount of pigments is typically from 2 to 20 percent by weight with respect to the polymer, and is preferably from 3 to 15 percent.

Colorants (colorant particles) which constitute the toner of the present invention may be subjected to surface modification. Employed as surface modifiers may be those which are conventionally known in the art. Specifically silane coupling agents, titanium coupling agents, and aluminum coupling agents may preferably be employed. Listed as silane coupling agents are, for example, alkoxysilanes such as methylmethoxysilane, phenylmethoxysilane, methylphenyldimethoxysilnae, diphenyldimethoxysilane, siloxanes such as hexamethyldisiloxane, γ-chloropropyltrimethoxysilane, vinyltrichlorosilane, vinyltrimethoxysilane, vinyltriethoxysilane, γ-methacryloxypropyltrimethoxysilane, γ-glycidoxypropyltrimethoxysilane, γ-mercaptopropyltrimethoxysilane, γ-aminopropyltriethoxysilane, and γ-ureidopropyltriethoxysilane. Listed as titanium coupling agents are, for example, TTS, 9S, 38S, 41B, 46B, 55, 138S, and 238S which are manufactured by Ajinomoto Co. Inc., and are commercially available under the product name “Preneact”, and commercially available products, A-1, B-1, TOT, TST, TAA, TAT, TLA, TOG, TBSTA, A-10, TBT, B-2, B-4, B-7, B-10, TBSTA-400, TTS, TOA-30, TSDMA, TTAB, and TTOP, manufactured by Nippon The Co., Ltd. Listed as an aluminum coupling agent is, for example, “Preneact AL-M”, manufactured by Ajinomoto Co., Inc.

The added amount of these surface modifiers is preferably from 0.01 to 20.00 percent by weight with respect to the colorant, and is more preferably from 0.2 to 5.0 percent. Further, listed as the surface modification method of colorant particles is a method in which surface modifiers are added to a colorant particle dispersion and the resulting mixture is heated so as to initiate a reaction. Surface modified colorant particles as above are collected by filtration. Subsequently, the collected particles are subjected to repeated washing and filtration employing the same solvent, and then dried to prepare the final product.

<Release Agents>

Preferred as compounds which exhibit a release function are low molecular weight polypropylene (having a number average molecular weight of 1,500 to 9,000) and low molecular weight polythylene. Particularly preferred compounds are the ester based compounds represented by the formula described below.

R₁—(OCO—R₂)ₙ

Wherein n is commonly an integer of 1 through 4; is preferably 2, 3, or 4; is more preferably 3 or 4; and is most preferably 4; and R₁ and R₂ each represents a hydrocarbon group which may have a substituent. R₁ has commonly from 1 to 40 carbon atoms, preferably from 1 to 20 carbon atoms, and more preferably from 2 to 5 carbon atoms. R₂ has commonly from 1 to 40 carbon atoms, preferably from 16 to 30 carbon atoms, and more preferably from 8 to 26 carbon atoms.

Examples of the representative compounds are shown below.

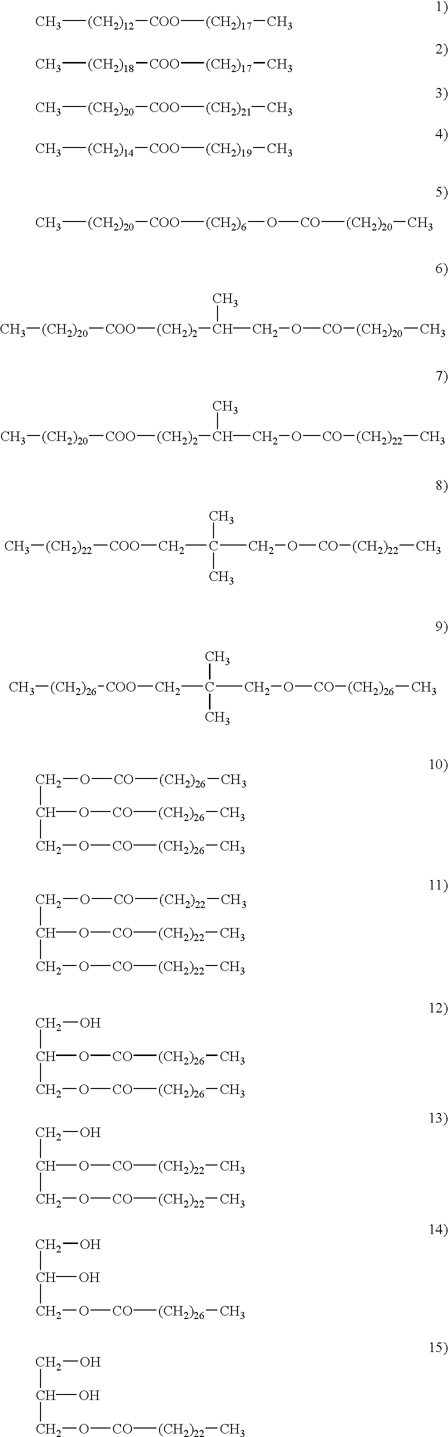

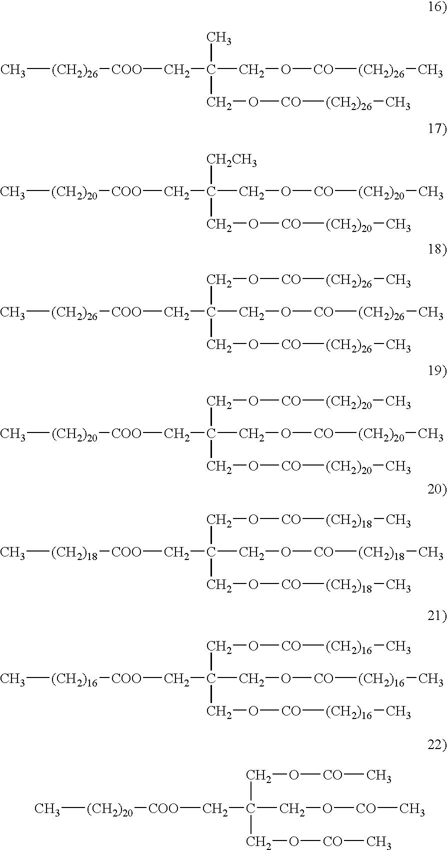

Further, in the present invention, crystalline substances may be used, and particularly, crystalline polyesters may be preferably used. As the crystalline polyesters, preferred are polyesters which are prepared by allowing aliphatic diols to react with aliphatic dicarboxylic acids (including acid anhydrides as well as acid chlorides).

Listed as diols which are used to prepare crystalline polyesters may be ethylene glycol, diethylene glycol, triethylene glycol, 1,2-propylene glycol, 1,3-propylene glycol, 1,4-butanediol, 1,4-butenediol, neopentyl glycol, 1,5-pentane glycol, 1,6-hexane glycol, 1,4-cyclohexanediol, 1,4-cyclohexanedimethanol, dipropylene glycol, polyethylene glycol, polypropylene glycol, polytetramethylene glycol, bisphenol A, bisphenol Z, and hydrogenated bisphenol A.

Listed as dicarboxylic acids to prepare crystalline polyesters may be oxalic acid, malonic acid, succinic acid, glutaric acid, adipic acid, pimelic acid, suberic acid, azelaic acid, sebacic acid, maleic acid, fumaric acid, citraconic acid, itaconic acid, glutaconic acid, n-dodecylsuccinic acid, n-dodecenylsuccinic acid, isodecylsuccinic acid, isodecenylcuccinic acid, n-octylsuccinic acid, n-octenylsuccinic acid, and acid anhydrides or acid chlorides thereof.

Listed as particularly preferable crystalline polyesters are polyesters which are prepared by allowing 1,4-cyclohexanedimethanol to react with adipic acid; polyesters which are prepared by allowing 1,6-hexanediol to react with sebacic acid; polyesters which are prepared by allowing ethylene glycol to react with succinic acid; polyesters which are prepared by allowing ethylene glycol to react with sebacic acid; and polyesters which are prepared by allowing 1,4-butanediol to react with succinic acid. Of these, most preferred are polyesters, which are prepared by allowing 1,4-cyclohexanedimethanol to react with adipic acid.

The added amount of the aforesaid compounds is typically from 1 to 30 percent by weight with respect to the total toner, is preferably from 2 to 20 percent, and is more preferably from 3 to 15 percent.

<Developers>

The toner of the present invention may be employed in either a single component developer or a double component developer. The single component developer includes a non-magnetic single component developer and a magnetic single component developer in which magnetic particles, having a size of about 0.1 to about 0.5 μm, are incorporated in the toner. The toner of the present invention may be employed in either of these.

Further, the toner of the present invention may be employed in the double component developer upon being mixed with a carrier. In such a case, employed as magnetic particles of the carrier may be materials such as metals, for example, iron, ferrite, and magnetite, and alloys of metals such as aluminum and lead with the metals, which are conventionally known in the art. Of these, ferrite particles are particularly preferred. The volume average particle diameter of the magnetic particles is preferably from 15 to 100 μm, and is more preferably from 25 to 80 μm.

It is possible to determine the volume average particle diameter of a carrier, employing a representative apparatus such as a laser diffraction type particle size analyzer “HELOS” (manufactured by Sympatec Co.) fitted with a wet type homogenizer.

Preferred as carriers are those in which magnetic particles are further coated with resins or so-called resin dispersed type carriers in which magnetic particles are dispersed in resins. Resin compositions for coating are not particularly limited. Employed as such resins are, for example, olefin based resins, styrene based resins, styrene-acryl based resins, silicone based resins, ester based resins, and fluorine-containing polymer based resins. Further, resins employed to constitute the resin dispersed type carrier are not particularly limited, and those known in the art may be employed. For example, employed may be styrene-acryl based resins, polyester resins, fluorine based resins, and phenol based resins.

### EXAMPLES

The embodiments as well as effects of the present invention will be specifically described with reference to examples. Needless to say, the embodiments of the present invention are not limited to these examples.

1. Production of Resinous Particles

(Resinous Particle 1HML)

(1) Preparation of Nucleus Particles (One Stage Polymerization)

Charged into a 5,000 ml separable flask fitted with a stirring unit, a temperature sensor, a cooling pipe, and a nitrogen inlet unit was a surface active agent solution (a water-based medium) which was prepared by dissolving 7.08 g of an anionic surface active agent (101), described below, in 3,010 g of deionized water. Subsequently, while stirring at 230 rpm, temperature in the flask was raised to 80° C. under a flow of nitrogen.

C₁₀H₂₁(OCH₂CH₂)₂OSO₃Na (101)

Added to the resulting surface active agent solution was an initiator solution prepared by dissolving 9.2 g of a polymerization initiator (potassium persulfate: KPS) in 200 g of deionized water, and subsequently, the resulting mixture was heated to 75° C. Thereafter, a monomer mix solution, comprised of 70.1 g of styrene, 19.9 g of n-butyl acrylate, and 10.9 g of methacrylic acid, was added dropwise over one hour. While stirring, the resulting system underwent polymerization (first stage polymerization) while heated to 75° C. for two hours, whereby resinous particles (a dispersion of resinous particles comprised of a high molecular weight resin) were prepared. The resulting particles were designated as “Resinous Particles (1H)”.

(2) Formation of the Interlayer (the Second Stage Polymerization)

Charged into a flask fitted with a stirring unit were 105.6 g of styrene, 30.0 g of n-butyl acrylate, 6.2 g of methacrylic acid, and 5.6 g of n-octyl-3-mercaptopropionic acid ester, and subsequently, 98.0 g of the compound represented by the aforesaid formula (19) (hereinafter referred to as “Exemplified Compound (19)” was added to the monomer mix solution and was then dissolved while heated to 90° C., whereby a monomer solution was prepared.

Separately, a surface active agent solution prepared by dissolving 1.6 g of the anionic surface active agent (the aforesaid formula (101)) in 2,700 ml of deionized water was heated to 98° C. Subsequently, 28 g of the Resinous Particles (1H) as a solid, which were employed as a dispersion of nucleus particles, was added to the resulting surface active agent solution. The resulting mixture was mixed with the aforesaid monomer solution comprising Exemplified Compound (19) and dispersed for 8 hours, employing a mechanical homogenizer “Clearmix” (manufactured by M-Technique Co., Ltd.), whereby a dispersion (an emulsion composition), comprising emulsified particles (oil droplets), was prepared.

Subsequently, an initiator solution prepared by dissolving 5.1 g of a polymerization initiator (KPS) in deionized water and 750 ml of deionized water were added to the dispersion (the emulsion composition), and while stirring, the resulting system underwent polymerization (second stage polymerization) over 12 hours while heated at 98° C., whereby resinous particles (dispersion of composite resinous particles having a structure in which the surface of resinous particles comprised of a high molecular weight resin was covered with a medium molecular weight resin) was prepared. The resulting particles were designated as “Resinous Particles (1H)”.

The aforesaid resinous particles (1HM) were dried and observed with a scanning type electron microscope, whereby particles (400 to 1,000 nm) comprised of Exemplified Compound (19) as a main component, which were not covered with latex were observed.

(3) Formation of Exterior Layer (Third Stage Polymerization)

An initiator solution prepared by dissolving 7.4 g of a polymerization initiator (KPS) in 200 ml of deionized water was added to Resinous Particles (1HM), prepared as above. Subsequently, a monomer mix solution comprised of 300 g of styrene, 95 g of n-butyl acrylate, 15.3 g of methacrylic acid, and 10.4 g of n-octyl-3-mercaptopropionic acid ester was added dropwise to the resulting mixture over one hour at 80° C. After the dropwise addition, while stirring, the resulting mixture underwent polymerization (third stage polymerization) for two hours while heated. Thereafter, the resulting product was cooled to 28° C., whereby a dispersion was prepared which comprised resinous particles (composite resinous particles having a central portion comprised of a high molecular weight resin, an interlayer comprised of an intermediate molecular weight resin, and an exterior layer comprised of a low molecular weight resin, and containing Exemplified Compound (19) in the interlayer. The resulting resinous particles were designated as “Resinous Particles (1HML).

The composite resin, constituting the Resinous Particles (1HML), has molecular weight peaks at 138,000, 80,000, and 13,000. Further, the weight average particle diameter of the composite resinous particles was 122 nm.

(Resinous Particles 2HML)

Resinous particles (dispersion of composite resinous particles having a central portion comprised of a high molecular weight resin, an interlayer comprised of an intermediate molecular weight resin, and an exterior layer comprised of a low molecular weight resin) were prepared in the same manner as Resinous Particles (1HML), except that surface active agent (101) was replaced with an anionic surface active agent (sodium dodecylbenzenesulfonate: SDS) in an amount of 7.08 g. The resulting resinous particles were designated as “Resinous Particles (2HML)”.

The composite resin, constituting the Resinous Particles (2HML), had molecular weight peaks at 138,000, 80,000, and 12,000. Further, the weight average particle diameter of the composite resinous particles was 110 nm.

2. Preparation of a Colored Particle Wet Cake

While stirring, 59.0 g of an anionic surface active agent (sodium dodecyl sulfate) was dissolved in 1,600 ml of deionized water. Subsequently, while stirring the resultant solution, 420.0 g of carbon black was gradually added. Thereafter, colorant particle dispersion was prepared by dispersing the resulting mixture, employing “Clearmix” (manufactured by M-Technique Co., Ltd.).

Charged into a reaction vessel (a four-necked flask) fitted with a temperature sensor, a cooling pipe, a nitrogen inlet unit, and a stirring unit were 420.7 g (in terms of solids) of Resinous Particles 1HML, 900 g of deionized water, and 166 g of colorant particle dispersion, and the resulting mixture was stirred. After regulating the interior temperature of the vessel to 30° C., a 5 mol/liter aqueous sodium hydroxide solution was added to adjust the pH to 8.

Subsequently, an aqueous solution prepared by dissolving a coagulant in the amount shown in Table 2 in 1,000 ml of deionized water was added while stirring at 30° C. over 10 minutes.

TABLE 2

| | | | Added Amount |
|---|---|---|---|
| | | | (in g) of |
| | Aggregation | Added Amount | Aggregation |
| | Terminating | (in g) of | Terminating |
| Coagulant | Agent | Coagulant | Agent |
| Magnesium | Sodium | 12.1 | 80.4 |
| Chloride | Chloride | | |
| hexahydrate | | | |

After being the aside for three minutes, an increase in temperature was initiated. The system was heated to 90° C. over 30 minutes and particle growth was initiated. The diameter of the growing particle was determined by a “Coulter Counter Multisizer”. When the volume average particle diameter reached 4 μm, the aggregation terminating agent in the amount shown in Table 2, which was dissolved in 1,000 ml of water, was added to terminate particle growth. Further, as a ripening process, the resulting dispersion was heated while stirring at 98° C. for two hours, whereby particle fusion was allowed to continue.

Thereafter, the resulting dispersion was cooled to 30° C. and the pH was adjusted to 2.0 by adding hydrochloric acid. Subsequently, stirring was terminated whereby a slurry comprising solid materials comprised of particles was obtained.

3. Preparation of Toner

<First Separation Step in Which Colored Particles are Subjected to Solid Liquid Separation from a Water-Based Medium>

The prepared slurry was filtered employing a 45 μm mesh filter. Thereafter, the resulting slurry was placed in the tank of a centrifuge, fitted with a filter cloth comprised of nonwoven fabric, and the slurry was subjected to solid separation by energizing the centrifuge at an acceleration of 700G, whereby 823 g of a wet cake in a solid amount of 56 percent was obtained. The Kraft point of the resultant filtrate was 6.2° C.

The prepared wet cake was designated as Wet Cake 1.

<Dispersing Step in Which Colored Particles are Dispersed in a Washing Medium>

Wet Cake 1 was dispersed in 1,000 ml of deionized water for 30 minutes, employing stirring blades.

<Skimming Step in Which Impurities Other than Colored Particles Floating in the Washing Medium are Removed from the Colored Particles Together With the Washing Medium>

The aforesaid dispersion was transferred to vessel having a closed bottom and the vessel was put onto the centrifuge apparatus. The dispersion was subjected to centrifugal separation at an acceleration of 700 G and the colored particles went down to the bottom. Subsequently, the washing medium comprising floating impurities was subjected to decantation.

Thereafter, in the same manner as the first separation step, the resultant colored particles were placed in the tank of a centrifuge in which unwoven fabric filter cloth was set, filtration was completed by supplying, to the tank of the centrifuge deionized water (having an electric conductivity of 1.0 μS/cm) in an amount of 0.2 liter/minute, while carrying out solid separations of the slurry by running the centrifuge at an acceleration of 700 G.

<Drying Step>

Thereafter, the resulting particles were dried by 40° C. air flow so as to achieve a water content of 0.63 percent.

<External Addition Step>

Toner was prepared by mixing the dried colored particles with hydrophobic silica in an amount of 1 percent by weight.

A prepared toner was designated as Toner 1.

Toner 2

Wet Cake 2 was prepared while processed in the same manner as Toner 1, except that Resinous Particles 1HML were replaced with 2HML. Subsequently, Toner 2 was prepared in the same manner as Toner 1, except that Wet Cake 2 was dispersed in 5,000 ml of deionized water for 30 minutes, employing stirring blades.

Comparative Toner 1

Toner was prepared in the same manner as Toner 1, except that the dispersing step and the skimming step were eliminated. The resultant toner was designated as Comparative Toner 1.

4. Practical Printing Evaluation

Evaluation was carried out employing a digital copier (Sitios Konica 7165), manufactured by Konica Corp. The digital copier was conditioned as described below for practical printing.

Charging Conditions

Charging unit: Scorotron charging unit, the initial charging potential was set at −750 V

Exposure conditions: Exposure amount was set so that the electric potential of the exposed portion resulted in −50 V.

Development Conditions

DC bias: −550 V

Transfer electrode: corona charging system

In the employed fixing apparatus, a heating roller, having a surface roughness, Ra, of 0.8 μm, was employed which was prepared by covering the surface of an iron roller with PF (a tetrafluoroethylene-perfluoroalkyl vinyl ether copolymer) so as to obtain a thickness of 25 μm and a pressure roller, having a surface roughness, Ra, of 0.8 μm, was employed which was prepared by covering HTV silicone rubber on an iron roller, employing a 120 μm thick PFA tube. Incidentally, the resultant nip width was 3.8 mm and the linear speed was 420 mm/second.

Incidentally, neither a cleaning mechanism nor an oil supply mechanism of the fixing apparatus was provided. The fixing temperature was controlled by the surface temperature of the heating roller and was set at 165° C.

With regard to printing conditions, 1,000,000 sheets were continuously printed at high temperature and high humidity (30° C. and 83 percent relative humidity). Evaluation was carried out based on the criteria described below.

(Photoreceptor Filming)

After printing the 1,000,000 sheets, the surface of the photoreceptor was visually observed and the presence or absence of filming was noted.

A: filming was not visually noted

B: filming was clearly noted

(Background Staining)

After continuously printing the 1,000,000 sheets, the density of non-image portions (white background portions) was determined employing a Macbeth densitometer.

A: relative density with respect to the unemployed transfer sheet is less than or equal to 0.004

B: relative density is at least 0.005.

(Insufficient Cleaning)

Evaluation was carried out by counting the number of sheets in which the white background was stained in such a manner that toner passed through the cleaning section.

TABLE 3

| | Photoreceptor | Background | Insufficient |
|---|---|---|---|
| Used Toner | Filming | Staining | Cleaning |
| Toner 1 | A | A | not occurred |
| | | | until |
| | | | 1,000,000 |
| | | | sheets |
| Toner 2 | A | A | not occurred |
| | | | until |
| | | | 1,000,000 |
| | | | sheets |
| Comparative | B | B | occurred at |
| Toner | | | 120,000th |
| | | | sheet |

Based on the results of Table 3, it is evident that Toners 1 and 2 of the present invention, in which washing medium is subjected to decantation, exhibit excellent characteristics, compared to the case in which Comparative Toner 1 is used.

### Effects of the Invention

According to the present invention, it is possible to effectively remove impurities in toner so as to minimize background staining due to insufficient charging, and to further minimize fusion of the toner onto an electrophotographic photoreceptor, as well as to minimize staining (filming).

What is claimed is:

1. A production method of electrostatic latent image developing toner, comprising:
a step of forming colored particles in water-based medium;
a first separation step of separating the colored particles from the water-based medium;
a step of dispersing the colored particles into a washing medium;
a step of skimming impurities other than the colored particles together with at least a part of the washing medium, the impurities drifting on the washing medium; and
a step of drying the colored particle so as to make the water content of the colored particles being 3% or less.

2. The production method of claim 1, wherein the colored particle forming step comprises aggregating and fusing at least resinous particles to make the colored particles in the water-based medium.

3. The production method of claim 1, wherein in the dispersing step, the weight of the washing medium is 10 to 100 times with respect to the weight equivalent to solid content of colored particles.

4. The production method of claim 1, wherein the first separating step comprises separating the colored particles and the water-based medium by a filtration utilizing a centrifugation.

5. The production method of claim 4, wherein the first separation step is completed by pouring the washing medium while the colored particles on a filter being subjected to the filtration.

6. The production method of claim 1, wherein the skimming step comprises subjecting the colored particles dispersed in the washing medium to centrifugation and skimming the drifting impurities together with the washing medium by decantation.

7. The production method of claim 1, wherein the production method further comprises a second separation step of separating the colored particles from the washing medium after the skimming step.

8. The production method of claim 7, wherein the second separating step comprises separating the colored particles and the washing medium by a filtration utilizing a centrifugation.

9. The production method of claim 8, wherein the second separating step is completed by pouring the washing medium while the colored particles on a filter being subjected to the centrifugation.
